(19) United States
(12) Patent Application Publication
(10) Pub. No.: US 2022/0092207 A1
(43) Pub. Date: Mar. 24, 2022

(54) DATA MANAGEMENT SYSTEM, DATA MANAGEMENT METHOD, AND PROGRAM

(71) Applicant: Mitsubishi Electric Corporation, Tokyo (JP)

(72) Inventors: Motoyuki OZAKI, Tokyo (JP); Osamu NASU, Tokyo (JP)

(73) Assignee: Mitsubishi Electric Corporation, Tokyo (JP)

(21) Appl. No.: 17/600,613

(22) PCT Filed: Jun. 28, 2019
(86) PCT No.: PCT/JP2019/025985

§ 371 Date: Oct. 1, 2021

(51) Int. Cl. G06F 21/62

(52) U.S. Cl. CPC G06F 21/6218

(57) ABSTRACT

A data management system includes a data processor (41) to collect machine data pieces repetitively transmitted from a machine, an encryptor (42) to encrypt the collected machine data pieces with encryption keys that are different among predetermined time sections, a DB (52) to store the encrypted machine data pieces, a DB server (51) to provide the machine data pieces stored in the DB (52), and a receiving client (60) to receive the machine data pieces from the DB server (51) and decrypt the machine data pieces.

### TECHNICAL FIELD

The present disclosure relates to a data management system, a data management method, and a program.

### BACKGROUND ART

As is common in facilities represented by factories, apparatuses process data collected from the facilities in real time so as to achieve production steps, inspection steps, and other various steps. The data to be processed is preferably encrypted against contingencies including abuse of the data. A conceivable solution is to apply techniques for encrypting the data (for example, refer to Patent Literature 1).

Patent Literature 1 discloses a technique of dividing digital content into a plurality of areas according to the authority of a user and encrypting the divided areas with mutually different keys. The user decrypts and views the area corresponding to the own authority in the encrypted digital content. This technique can selectively control disclosure of information depending on the user.

A conceivable data management procedure can be configured by applying the technique disclosed in Patent Literature 1 to an actual worksite of factory automation (FA). In this procedure, for example, various types of data collected in a facility are categorized according to the types, encrypted with mutually different keys, and stored into a server in advance. An operator is thus allowed to decrypt and view the data corresponding to the authority provided to the operator.

### CITATION LIST

### Patent Literature

Patent Literature 1: Unexamined Japanese Patent Application Publication No. 2007-251921

### SUMMARY OF INVENTION

### Technical Problem

In some actual worksites of FA, apparatuses are required to collect streaming data that is continuously output. In a system of using encryption keys different among types of data, leakage of one of the encryption keys may lead to endless leakage of the data of the type decryptable with the leaked encryption key, for example. That is, the technique disclosed in Patent Literature 1 may result in an increase in the risk in the case of leakage of data in facilities represented by factories.

An objective of the present disclosure, which has been accomplished in view of the above situations, is to reduce the risk in the case of leakage of data in facilities represented by factories.

### Solution to Problem

In order to achieve the above objective, a data management system according to an aspect of the present disclosure includes a data management apparatus connected to a machine, including: collection means for collecting machine data pieces repetitively transmitted from the machine; encryption means for encrypting the machine data pieces collected by the collection means with encryption keys that are different among predetermined time sections; storage means for storing the machine data pieces encrypted by the encryption means; provision means for providing the machine data pieces stored in the storage means; and reception means for receiving the machine data pieces from the provision means and decrypting the machine data pieces.

### Advantageous Effects of Invention

According to an aspect of the present disclosure, the encryption means encrypts the machine data pieces with the encryption keys different among the predetermined time sections. This configuration can prevent the machine data pieces from being continuously leaked in the case of leakage of an encryption key. The configuration can therefore reduce the risk in the case of leakage of data in facilities represented by factories.

### BRIEF DESCRIPTION OF DRAWINGS

FIG. 1 is a block diagram illustrating a configuration of a data management system according to an embodiment of the present disclosure;

FIG. 2 illustrates a hardware configuration of a data management apparatus according to the embodiment;

FIG. 3 illustrates exemplary setting for a processing flow according to the embodiment;

FIG. 4 illustrates a functional configuration of the data management apparatus according to the embodiment;

FIG. 5 is a diagram for describing a scheme of sharing of a common key according to the embodiment;

FIG. 6 is a diagram for describing a scheme of transmission and reception of data according to the embodiment;

FIG. 7 is a flowchart illustrating a transmission process according to the embodiment;

FIG. 8 illustrates exemplary data stored in a DB according to the embodiment;

FIG. 9 is a flowchart illustrating a reception process according to the embodiment;

FIG. 10 illustrates transmission and reception of information between a sending client and a receiving client according to the embodiment;

FIG. 11 illustrates a configuration of a data management apparatus according to a modification; and

FIG. 12 illustrates a processing flow according to a modification.

### DESCRIPTION OF EMBODIMENTS

A data management apparatus 10 according to an embodiment of the present disclosure is described in detail below with reference to the accompanying drawings.

### Embodiment

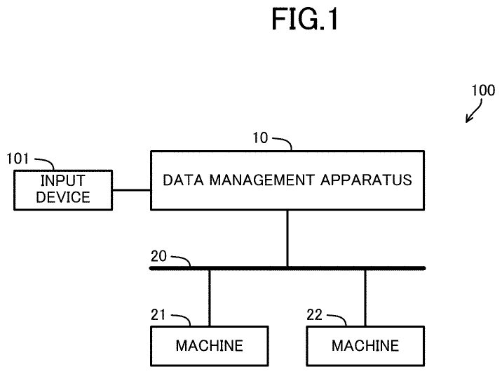

The data management apparatus 10 according to the embodiment is an industrial personal computer (IPC) installed in a factory, for example. As illustrated in FIG. 1, the data management apparatus 10 is connected to machines 21 and 22 disposed on a production line in the factory via industrial networks 20, and connected to an input device 101 for input of setting for processes via a dedicated line. The data management apparatus 10, the input device 101, and the machines 21 and 22 constitute a data management system 100 serving as a factory automation (FA) system. The data management apparatus 10 processes data collected from the machine 21 via the network 20 and outputs a control command associated with a result of processing to the machine 22. The machine 21 is a sensor while the machine 22 is an actuator or robot.

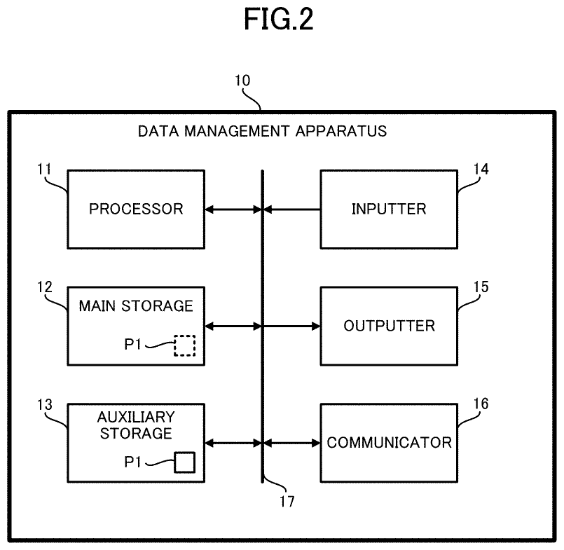

As illustrated in FIG. 2, the data management apparatus 10 has a hardware configuration including a processor 11, a main storage 12, an auxiliary storage 13, an inputter 14, an outputter 15, and a communicator 16. The main storage 12, the auxiliary storage 13, the inputter 14, the outputter 15, and the communicator 16 are each connected to the processor 11 via internal buses 17.

The processor 11 includes a central processing unit (CPU). The processor 11 executes a program P1 stored in the auxiliary storage 13 and thereby performs various functions of the data management apparatus 10 and executes the below-described operations.

The main storage 12 includes a random access memory (RAM). The program P1 is loaded from the auxiliary storage 13 into the main storage 12. The main storage 12 serves as a work area of the processor 11.

The auxiliary storage 13 includes a non-volatile memory, represented by an electrically erasable programmable read-only memory (EEPROM) or a hard disk drive (HDD). The auxiliary storage 13 stores the program P1 and various types of data used in processes in the processor 11. The auxiliary storage 13 provides the processor 11 with data to be used by the processor 11 and stores data fed from the processor 11 under the instructions from the processor 11. Although FIG. 2 illustrates a single program P1 as a representative, the auxiliary storage 13 may store a plurality of programs, and the programs may be loaded into the main storage 12.

The inputter 14 includes an input device, represented by an input key or pointing device. The inputter 14 acquires information input by a user of the data management apparatus 10 and provides the acquired information to the processor 11.

The outputter 15 includes an output device, represented by a liquid crystal display (LCD) or speaker. The outputter 15 presents various types of information to the user under the instructions from the processor 11.

The communicator 16 includes a network interface circuit to communicate with external apparatuses. The communicator 16 receives signals from the outside and outputs data indicated by the signals to the processor 11. The communicator 16 also transmits signals indicating the data output from the processor 11 to external apparatuses.

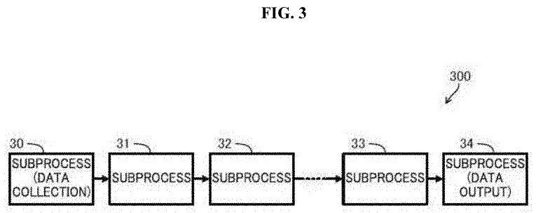

The hardware components illustrated in FIG. 2 cooperate with each other and thereby allow the data management apparatus 10 to perform various functions including data processing. The data processing in the data management apparatus 10 is arbitrarily defined by the user as a processing flow 300 involving a series of subprocesses 30, 31, 32, 33, and 34 to be sequentially executed, as illustrated in the example illustrated in FIG. 3.

The processing flow 300 involves subprocesses sequentially applied to machine data output from the machine 21. In detail, the processing flow 300 is achieved by executing a subprocess 30 of collecting data to be processed, which is a subject of the processing flow 300, subprocesses 31 to 33, and a subprocess 34 of outputting data indicating a result of the processing flow 300, in the order mentioned. The data to be processed indicates machine data to be subject to the processing flow 300. The arrows in FIG. 3 represent transmission of machine data to be subject to the individual subprocesses. In the description below, the unprocessed machine data output from the machine 21 and the machine data output from the machine 21 and then processed are collectively referred to as “machine data”. For example, machine data acquired from the outside of the data management apparatus 10 through the subprocess 30 is input to the subprocess 31 and undergoes the subprocess 31. The machine data indicating a result of the subprocess 31 is output from the subprocess 31 and input to the subprocess 32, and then undergoes the subprocess 32. The machine data indicating a result of the subprocess 33 is output from the subprocess 33 to the subprocess 34 as a subject of the subprocess 34, and is then output to the outside of the data management apparatus 10.

The subprocess 30 corresponds to a subprocess of receiving a signal from the machine 21 via the network 20 illustrated in FIG. 1 and thereby collecting machine data to be processed. The machine 21 periodically transmits data to be processed indicating a sensing result, leading to periodic execution of the subprocess 30. The period is, for example, 10 ms, 100 ms, or 1 sec. The data to be processed, which indicates a sensing result, is an 8-bit or 16-bit digital value, for example. The repetitively input series of processing data pieces constitute chronological data, each of which undergoes the processing flow 300.

The subprocesses 31 to 33 are each a subprocess repetitively executed in response to execution of the subprocess 30. The subprocesses 31 to 33 correspond to, for example, a subprocess of calculating a moving average, a subprocess of determining whether the value to be processed exceeds a predetermined threshold, and a subprocess of determining the content of a control command directed to the machine 22 in FIG. 1, respectively. These subprocesses 31 to 33 allow a specific control command to be output only if the value provided by calculating the moving average of a sensing result and thereby removing noise from the sensing result exceeds the threshold.

The above-described subprocesses 31 to 33 are mere examples. For example, the subprocesses 31 to 33 may also be a subprocess of rounding fractions or a normalizing subprocess to make an input value fall within a predetermined range, a scaling subprocess of multiplying an input value with a predetermined constant, a shifting subprocess of adding a predetermined offset value to an input value, a filtering subprocess or statistical subprocess different from the subprocess of calculating a moving average, a transforming subprocess represented by the fast Fourier transform (FFT), other modifying subprocess or diagnostic subprocess, or another subprocess.

The subprocess 34 corresponds to a subprocess of transmitting a result of the subprocess 33 to the machine 22 via the network 20 illustrated in FIG. 1. The subprocess 34 is not necessarily a subprocess of transmitting data to the machine 22, and may be a subprocess of outputting an instruction to execute a predesignated program, a subprocess of displaying a result of the processing flow on a screen, a subprocess of transmitting information to another apparatus, or another outputting subprocess. The following description is mainly directed to an exemplary subprocess of transmitting data acquired through the processing flow 300 to the machine 22 in the form of a control command.

The individual subprocesses 30 to 34 are successively executed for the repetitively input data pieces to be processed. For example, a single data piece to be processed undergoes the subprocesses 30 to 34 in sequence, and the subsequent data piece to be processed then undergoes the subprocesses 30 to 34 in sequence. Alternatively, the processing flow for the single data piece to be processed may be executed in parallel to the processing flow for the subsequent data piece to be processed. That is, a processing flow may be initiated before termination of the previous processing flow. Although FIG. 3 illustrates five representative subprocesses 30 to 34 involved in the processing flow 300, the number of subprocesses may be four or smaller and may be six or larger.

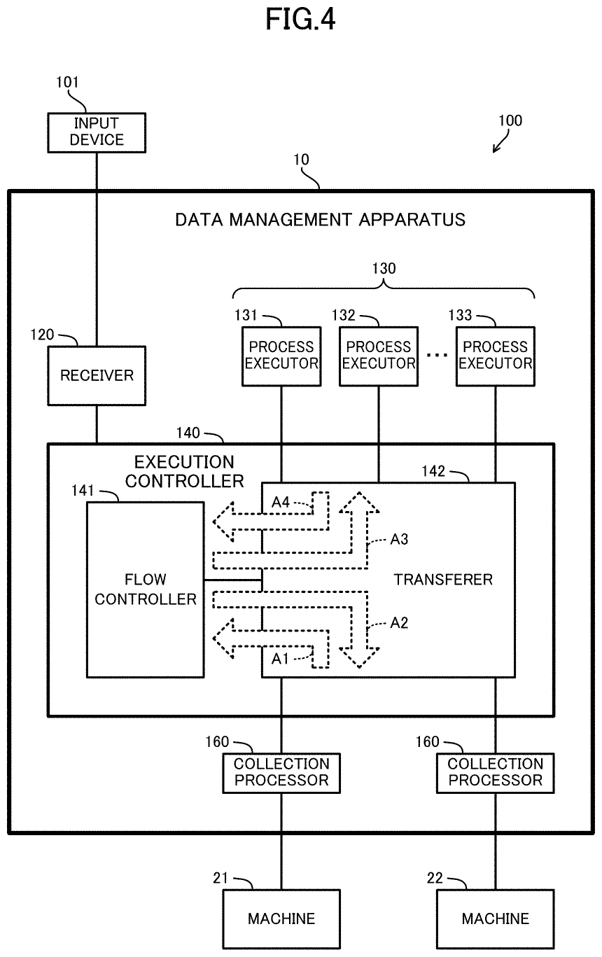

In order to execute the processing flow 300 illustrated in FIG. 3, the data management apparatus 10 has a functional configuration illustrated in FIG. 4. In detail, the data management apparatus 10 includes a receiver 120 to receive setting for the processing flow, process executors 131, 132, and 133 to execute subprocesses, an execution controller 140 to control execution of the processing flow, and collection processors 160 to collect data and output control commands.

The receiver 120 is mainly achieved by the processor 11. The receiver 120 receives setting for the processing flow that defines subprocesses sequentially applied to data. The receiver 120 informs the execution controller 140 of the setting for the processing flow. The receiver 120 also receives setting related to encryption, which is described below. The setting related to encryption contains, for example, setting related to time sections for use of different encryption keys. The receiver 120 is an example of setting reception means for receiving setting for time sections in the data management system 100.

The process executors 131 to 133 are mainly achieved by cooperation of the processor 11 and the main storage 12 and execute the respective subprocesses 31 to 33. In detail, each of the process executors 131 to 133 is achieved by execution of a software module stored in the auxiliary storage 13 by the processor 11. This software module may be plug-in software stored into the auxiliary storage 13 by the user. The plug-in software may be designed by the user, purchased by the user, or obtained by the user as open-source software. The process executors 131 to 133 are hereinafter collectively referred to as “process executors 130”. The process executors 130 correspond to an example of a plurality of processing means for executing different subprocesses to be sequentially executed that are involved in a processing flow, in the data management system 100.

The process executors 130 do not necessarily have one-to-one correspondence with the subprocesses involved in the processing flow 300 illustrated in FIG. 3. In an exemplary case where the same subprocess is applied to machine data twice, these two subprocesses connected in the processing flow 300 may be both executed by a single process executor 130.

The execution controller 140 is mainly achieved by cooperation of the processor 11 and the main storage 12. The execution controller 140 relays machine data transmitted and received between a process executor 130 and another process executor 130 and relays data transmitted and received between a process executor 130 and a collection processor 160, thereby causing the process executors 130 and the collection processors 160 to execute the subprocesses in the order in accordance with the setting for the processing flow. The execution controller 140 includes a flow controller 141 to determine the subprocesses to be applied to machine data in accordance with the setting for the processing flow and control the data flow, and a transferer 142 to relay data between the flow controller 141 and any of the process executors 130 and the collection processors 160.

The flow controller 141 acquires data from any of the process executors 130 and the collection processors 160 via the transferer 142 and outputs the acquired data to any of the process executors 130 and the collection processors 160 via the transferer 142. For example, the flow controller 141 acquires the data to be processed collected by the collection processor 160 via the transferer 142, as represented by the arrow A1 in FIG. 4. The flow controller 141 then outputs the machine data to the transferer 142, as represented by the arrow A3, and thereby causes the process executor 131 that receives the machine data from the transferer 142 to execute a subprocess. In another example, the flow controller 141 acquires machine data indicating a result of the subprocess from the process executor 130 via the transferer 142, as represented by the arrow A4. The flow controller 141 then outputs the machine data to the transferer 142, as represented by the arrow A3, and thereby causes another process executor 130 that receives the machine data from the transferer 142 to execute the subsequent subprocess.

When the flow controller 141 acquires the machine data indicating a result of the last subprocess from the process executor 133 via the transferer 142, as represented by the arrow A4, the flow controller 141 outputs the machine data to the collection processor 160 in the form of a control command to be transmitted to the machine 22, as represented by the arrow A2. In the case where another outputting subprocess is defined as an output of the processing flow, other than the subprocess of transmitting a control command to the machine 22, the flow controller 141 executes steps to achieve the defined outputting subprocess. For example, if the defined subprocess is a subprocess of displaying a result of the processing flow on a screen, the flow controller 141 may output data for causing the outputter 15 including the LCD to display the result.

The transferer 142 is installed as a server function. The transferer 142 transfers data from the process executors 130 and the collection processors 160 to the flow controller 141, as represented by the arrows A1 and A4, and transfers data from the flow controller 141 to any of the process executors 130 and the collection processors 160, as represented by the arrow A2 or A3.

The collection processors 160 are mainly achieved by the communicator 16 and execute the subprocesses 30 and 34. In detail, each of the collection processors 160 is achieved by execution of a software module stored in the auxiliary storage 13 by the processor 11, like the process executor 130. The collection processor 160 provides the execution controller 140 with information pieces repetitively transmitted from the machine 21, and provides the machine 22 with the control commend output from the execution controller 140. A plurality of collection processors 160 is provided depending on the types of industrial networks connected to the data management apparatus 10. Although FIG. 4 illustrates a plurality of collection processors 160, a single collection processor 160 may be connected to both of the machines 21 and 22 if the machines 21 and 22 are both connected to a single industrial network.

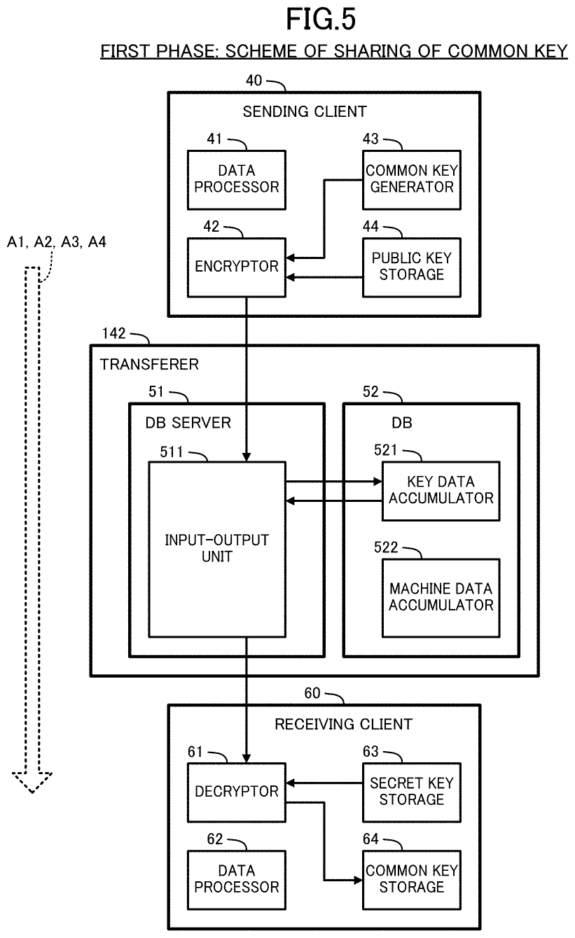

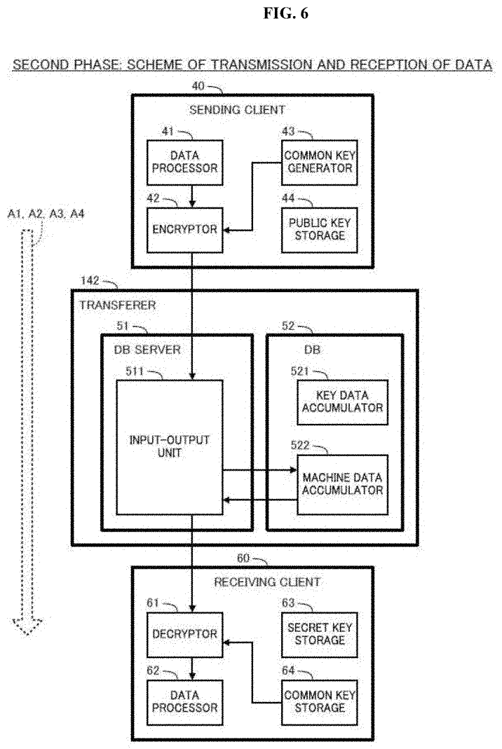

Between the flow controller 141 and any of the process executors 130 and the collection processors 160, data after encryption is transferred along the transmission paths represented by the arrows Al to A4. A configuration for encrypting data to be transferred via the transferer 142 is described in detail below with reference to FIGS. 5 and 6.

FIGS. 5 and 6 illustrate a sending client 40 to transmit machine data along the arrows A1 to A4 and a receiving client 60 to receive the machine data. The sending client 40 and the receiving client 60 each correspond to any of the process executors 130, the flow controller 141, and the collection processors 160. In an exemplary case of transfer of machine data along the arrow A1, the collection processor 160 corresponds to the sending client 40 while the flow controller 141 corresponds to the receiving client 60. In another exemplary case of transfer of machine data along the arrow A2, the flow controller 141 corresponds to the sending client 40 while the collection processor 160 corresponds to the receiving client 60. In another exemplary case of transfer of machine data along the arrow A3, the flow controller 141 corresponds to the sending client 40 while the process executor 130 corresponds to the receiving client 60. In another exemplary case of transfer of machine data along the arrow A4, the process executor 130 corresponds to the sending client 40 while the flow controller 141 corresponds to the receiving client 60.

The machine data is encrypted in two phases. In detail, the two phases include the first phase, in which a common key to be used in encryption of the machine data is encrypted in a public key cryptosystem and then shared between the sending client 40 and the receiving client 60, and the second phase, in which the machine data is encrypted with the shared common key and then transferred.

FIG. 5 illustrates paths of information transferred in the first phase by the solid-line arrows. As illustrated in FIG. 5, the sending client 40 includes a data processor 41 to process machine data, an encryptor 42 to encrypt a common key with a public key for the receiving client 60, a common key generator 43 to generate the common key, and a public key storage 44 to preliminarily acquire and store the public key for the receiving client 60.

The encryptor 42 encrypts the common key generated by the common key generator 43 with the public key read from the public key storage 44, and transmits the common key to the transferer 142. The common key after encryption is hereinafter referred to as “encrypted common key” as required. The encryptor 42 corresponds to an example of encryption means for encrypting data in the data management system 100.

The transferer 142 includes a database (DB) server 51 to function as a server for the sending client 40 and the receiving client 60, and a DB 52 to accumulate various types of information.

The DB server 51 includes an input-output unit 511 to transmit and receive information to and from the outside of the transferer 142. The input-output unit 511 causes the encrypted common key transmitted from the encryptor 42 of the sending client 40 to be stored into a key data accumulator 521 of the DB 52. In response to a request from the receiving client 60, the input-output unit 511 reads the encrypted common key from the key data accumulator 521 and transmits the encrypted common key to the receiving client 60. The DB server 51 corresponds to an example of provision means for providing the data stored in the DB 52 in the data management system 100.

The DB 52 includes the key data accumulator 521 to accumulate encrypted common keys and a machine data accumulator 522 to accumulate machine data after encryption. The DB 52 corresponds to an example of storage means for storing encrypted data in the data management system 100. The machine data accumulator 522 does not perform the function in the first phase.

The receiving client 60 corresponds to an example of reception means for receiving and decrypting the data provided from the DB server 51 in the data management system 100. The receiving client 60 includes a decryptor 61 to decrypt the encrypted common key, a data processor 62 to process the machine data, a secret key storage 63 to store a secret key for the receiving client 60 itself, and a common key storage 64 to store the common key after decryption by the decryptor 61.

The decryptor 61 provides the DB server 51 with a request for an encrypted common key directed to the receiving client 60, and thereby acquires the encrypted common key. Alternatively, the decryptor 61 may read and acquire the encrypted common key directly from the DB 52, without a request to the DB server 51. The decryptor 61 then decodes the acquired encrypted common key with the secret key read from the secret key storage 63, and causes the common key obtained through decryption to be stored into the common key storage 64. Alternatively, the data processor 62 may generate a pair of a secret key and a public key for the receiving client 60, store the generated secret key into the secret key storage 63, and transmit the generated public key to the sending client 40 via the transferer 142.

The above-described functions of the sending client 40, the transferer 142, and the receiving client 60 allow the common key to be shared between the sending client 40 and the receiving client 60. The sending client 40 may acquire the public key for the receiving client 60 in any procedure. For example, the sending client 40 may acquire the public key directly from the receiving client 60 or may acquire the public key via the transferer 142 in advance of the transmission of the encrypted common key to the transferer 142. The DB 52 of the transferer 142 may also cause public keys for the receiving client 60 to be accumulated in the key data accumulator 521 in addition to the encrypted common keys, and may provide the public keys to the sending client 40 as required.

FIG. 6 illustrates paths of information transferred in the second phase by the solid-line arrows. As illustrated in FIG. 6, the data processor 41 of the sending client 40 outputs machine data to the encryptor 42. If the sending client 40 corresponds to any of the process executors 130 and the collection processors 160, the data processor 41 executes a subprocess. If the sending client 40 corresponds to the collection processor 160, the data processor 41 corresponds to an example of collection means for collecting machine data pieces repetitively transmitted from the machine 21, in the data management system 100. If the sending client 40 corresponds to the flow controller 141, the sending client 40 may be configured without the data processor 41.

The encryptor 42 encrypts the machine data output from the data processor 41 with the common key provided from the common key generator 43 and transmits the machine data to the transferer 142. The common key provided from the common key generator 43 is identical to the common key shared in the first phase illustrated in FIG. 5. The machine data after encryption is hereinafter referred to as “encrypted machine data” as required.

The input-output unit 511 of the transferer 142 causes the encrypted machine data transmitted from the encryptor 42 of the sending client 40 to be stored into the machine data accumulator 522 of the DB 52. In response to a request from the receiving client 60, the input-output unit 511 reads the encrypted machine data from the machine data accumulator 522 and transmits the encrypted machine data to the receiving client 60.

The decryptor 61 of the receiving client 60 provides the DB server 51 with a request for encrypted machine data directed to the receiving client 60, and thereby acquires the encrypted machine data. Alternatively, the decryptor 61 may read and acquire the encrypted machine data directly from the DB 52 without a request to the DB server 51. The decryptor 61 decrypts the acquired encrypted machine data with the common key read from the common key storage 64, and outputs the machine data obtained through decryption to the data processor 62. If the receiving client 60 corresponds to any of the process executors 130 and the collection processors 160, the data processor 62 executes a subprocess. If the receiving client 60 corresponds to the flow controller 141, the receiving client 60 may be configured without the data processor 62.

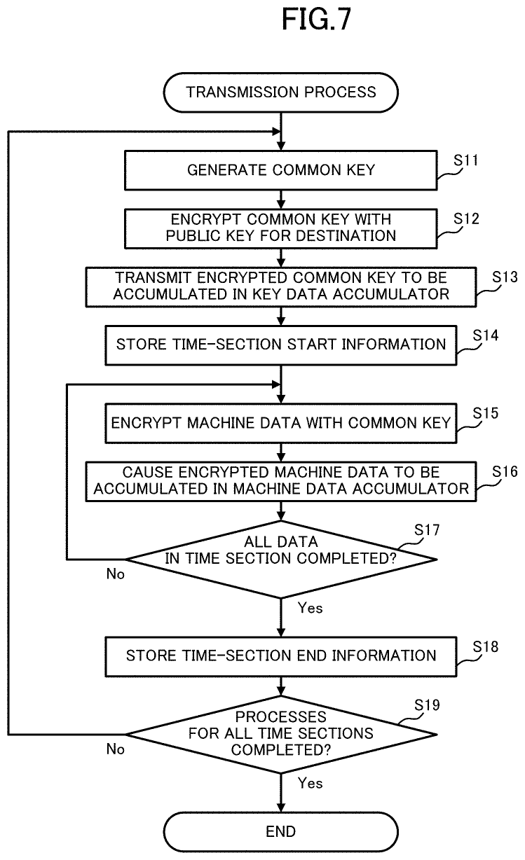

A process executed in the data management apparatus 10 is described below with reference to FIGS. 7 to 9. Specifically, a transmission process executed by the sending client 40 in FIGS. 5 and 6 and a reception process executed by the receiving client 60 are described in sequence. The above description is directed to the configuration for encrypting machine data with reference to FIGS. 5 and 6. The data management apparatus 10 encrypts machine data using common keys for encryption different among the predetermined time sections. The following description is directed to exemplary encryption with such common keys different among the time sections.

As illustrated in FIG. 7, in the transmission process, the common key generator 43 of the sending client 40 generates a common key for encryption of machine data to be transmitted (Step S11). The common key is an encryption key in accordance with a so-called common key cryptosystem. Examples of the common key cryptosystem include triple data encryption standard (DES), advanced encryption standard (AES), and other cryptosystems.

The encryptor 42 then encrypts the common key generated in Step S11 with a public key preliminarily acquired from the receiving client 60, which is the destination of the common key (Step S12). This public key corresponds to the key that is made public among the pair of the secret key and the public key generated in accordance with a so-called public key cryptosystem. Examples of the public key cryptosystem include Rivest Shamir Adleman (RSA) algorithm and elliptic curve digital signature algorithm (DSA).

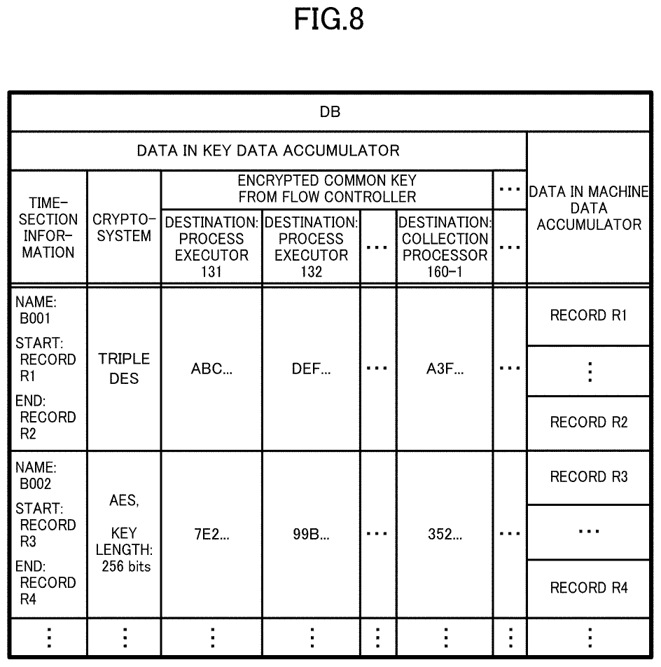

The encryptor 42 then transmits the encrypted common key generated in Step S12 to the transferer 142, and causes the encrypted common key to be accumulated in the key data accumulator 521 of the DB 52 (Step S13). In an exemplary case where the sending client 40 corresponds to the flow controller 141 while the receiving client 60 corresponds to the process executor 131, the encrypted common key “ABC . . .” illustrated in FIG. 8, among the data stored in the DB 52 illustrated in FIG. 5, is stored into the key data accumulator 521. The encryptor 42 also generates encrypted common keys “DEF . . . ” and “A3F . . . ” for transmission of data to a plurality of receiving clients 60, and causes the encrypted common keys to be stored into the key data accumulator 521. The key data accumulator 521 accumulates encrypted common keys transmitted from a plurality of origins, which are the sending clients 40.

Referring back to FIG. 7, after Step S13, the encryptor 42 transmits time-section start information to the transferer 142 and causes the time-section start information to be stored into the key data accumulator 521 (Step S14). The time-section start information indicates start of a time section within which an identical common key is used. The time-section start information may specify the record at the start of the time section, as in the example illustrated in FIG. 8. The encryptor 42 also causes a cryptosystem applied in this time section to be stored into the key data accumulator 521 in association with the time-section start information. Thus, the information indicating that the encrypted common key is in accordance with the cryptosystem “triple DES” is stored, as in the example illustrated in FIG. 8.

The encryptor 42 then encrypts the machine data output from the data processor 41 with the common key generated in Step S11 (Step S15). The encryptor 42 then transmits the encrypted machine data generated in Step S15 to the transferer 142, and thereby causes the encrypted machine data to be accumulated in the machine data accumulator 522 of the DB 52 (Step S16). The data “record R1” is thus stored as in the example illustrated in FIG. 8.

The encryptor 42 then determines whether transmission of all the data in the time section is completed (Step S17). Specifically, the encryptor 42 determines completion of transmission of all the machine data to be transmitted in the same time section as that of the encrypted machine data transmitted in Step S16.

The time sections are defined in accordance with the setting preliminarily received by the receiver 120. The time sections may be defined by a constant period. The constant period is, for example, 1 ms or 1 sec. Alternatively, the time sections may be divided on the basis of the comparison of the value indicated by the machine data stored in the machine data accumulator 522 with a threshold. For example, a new time section may start when the value indicated by the machine data exceeds the threshold. Alternatively, the time sections may be defined depending on the value of data to be processed, which is a subject of the processing flow 300. In an exemplary case where the data to be processed contains a value indicating an operation mode of the machine 21, the time sections may be defined on the basis of the operation mode.

If determining that transmission of all the data in the time section is not completed in Step S17 (Step S17; No), the encryptor 42 repeats Step S15 and the following steps. These steps cause the machine data from “record R1” to “record R2” corresponding to the time section named as “B001” to be stored into the DB 52, as in the example illustrated in FIG. 8.

In contrast, if determining that transmission of all the data in the time section is completed (Step S17; Yes), the encryptor 42 transmits time-section end information to the transferer 142 and causes the time-section end information to be stored into the key data accumulator 521 of the DB 52 (Step S18). The time-section end information specifies the record at the end of the time section, as in the example illustrated in FIG. 8.

Referring back to FIG. 7, after Step S18, the encryptor 42 determines whether the processes for all the time sections are completed (Step S19). Specifically, the encryptor 42 determines whether any instruction to interrupt the processing flow 300 is input. If determining that the processes for all the time sections are not completed (Step S19; No), the encryptor 42 repeats Step S11 and the following steps. These steps allow the encryptor 42 to encrypt machine data with encryption keys different among the predetermined time sections, and cause the encrypted common key and the machine data associated with the new time section “B002” to be stored into the DB 52, as in the example illustrated in FIG. 8. In contrast, if the processes for all the time sections are determined to be completed (Step S19; Yes), the transmission process is terminated.

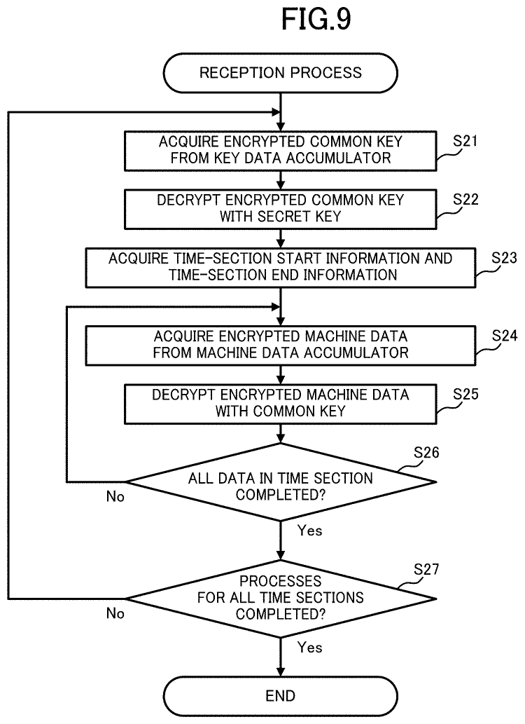

The reception process executed by the receiving client 60 is described below with reference to FIG. 9. As illustrated in FIG. 9, in the reception process, the decryptor 61 of the receiving client 60 acquires the encrypted common key from the key data accumulator 521 (Step S21). Specifically, the decryptor 61 provides the transferer 142 with a request for the encrypted common key directed to the receiving client 60 and acquires the encrypted common key provided in response to the request.

The decryptor 61 then decrypts the encrypted common key acquired in Step S21 with a secret key (Step S22). The decryptor 61 then acquires the time-section start information and the time-section end information, like acquiring the encrypted common key (Step S23). The decryptor 61 is thus able to determine whether the time section associated with the encrypted common key acquired in Step S21 is newly started, continued, or ended. The decryptor 61 also acquires the information indicating the cryptosystem in association with the time-section start information and the time-section end information.

The decryptor 61 then acquires the encrypted machine data from the machine data accumulator 522 (Step S24). Specifically, the decryptor 61 provides the transferer 142 with a request for the encrypted machine data and receives the encrypted machine data provided in response to the request. The decryptor 61 thus acquires the encrypted machine data “record R1” associated with the encrypted common key “ABC . . . ” illustrated in FIG. 8, for example.

The decryptor 61 then decrypts the encrypted machine data acquired in Step S24 with the common key decrypted in Step S22 (Step S25). The decryptor 61 then determines whether reception of all the data in the time section is completed (Step S26).

Specifically, the decryptor 61 determines completion of acquisition of all the machine data belonging to the same time section as that of the machine data acquired in Step S24. In other words, the decryptor 61 determines whether the time section ends.

This determination is based on the time-section end information acquired in Step S23. In the case of the time section dynamically determined depending on the value of the machine data or the data to be processed, the decryptor 61 may monitor the time-section end information acquired from the key data accumulator 521 and thereby determine whether the time section ends, because the decryptor 61 is not able to determine whether the time section ends even after the start of the time section.

The decryptor 61 does not necessarily determine the end of the time section in accordance with the time-section end information. For example, the decryptor 61 may determine the encrypted machine data belongs to a new time section after switching of the time section, in response to failure of decryption of the encrypted machine data with the common key.

If determining that reception of all the data in the time section is not completed (Step S26; No), the decryptor 61 repeats Step S24 and the following steps. The decryptor 61 thus acquires all the machine data containing the last encrypted machine data “record R2” associated with the encrypted common key “ABC . . .” illustrated in FIG. 8, for example.

In contrast, if determining that reception of all the data in the time section is completed (Step S26; Yes), the decryptor 61 determines whether the processes for all the time sections are completed (Step S27). Specifically, the decryptor 61 determines whether any instruction to interrupt the processing flow 300 is input. If determining that the processes for all the time sections are not completed (Step S27; No), the decryptor 61 repeats Step S21 and the following steps. The decryptor 61 thus acquires and decrypts both of the encrypted common key and the encrypted machine data associated with the new time section. In contrast, if the processes for all the time sections are determined to be completed (Step S27; Yes), the reception process is terminated.

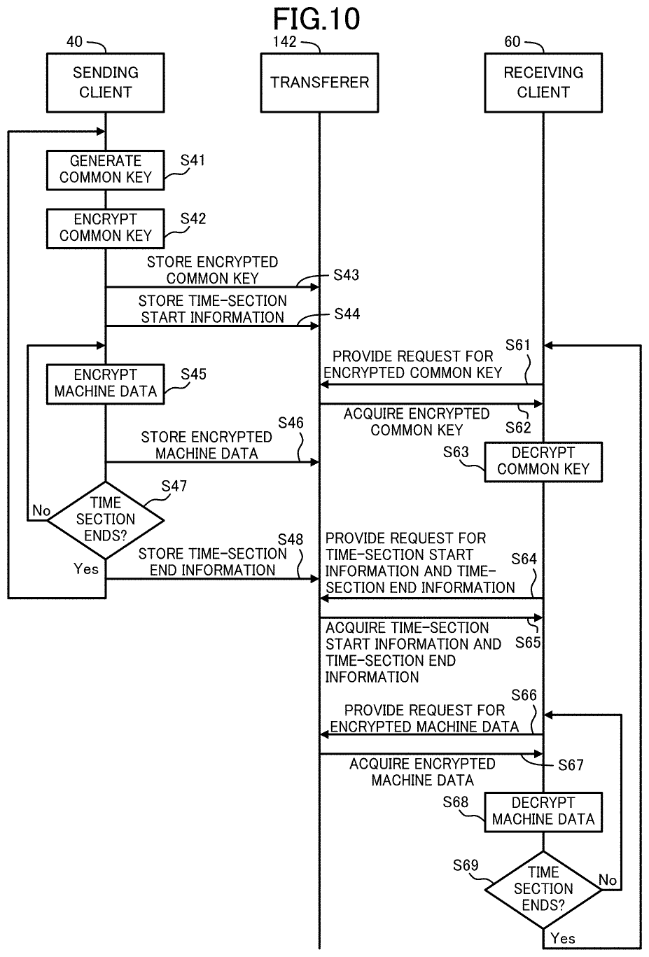

FIG. 10 is a schematic diagram illustrating transmission and reception of information among the sending client 40, the transferer 142, and the receiving client 60. As illustrated in FIG. 10, the sending client 40 generates a common key (Step S41), and encrypts the common key (Step S42). The sending client 40 then transmits the encrypted common key to the transferer 142 to cause the encrypted common key to be stored into the DB 52 (Step S43), and causes time-section start information to be stored into the DB 52 (Step S44). The sending client 40 then encrypts machine data (Step S45), and transmits the encrypted machine data to the transferer 142 to cause the encrypted machine data to be stored into the DB 52 (Step S46). The sending client 40 then determines whether the time section ends (Step S47). If determining that the time section does not end (Step S47; No), the sending client 40 repeats Step S45 and the following steps. In contrast, if determining that the time section ends (Step S47; Yes), the sending client 40 causes time-section end information to be stored into the DB 52 (Step S48), and repeats Step S41 and the following steps. These steps can achieve transmission of the encrypted common key and the encrypted machine data in a new time section.

The receiving client 60 provides the transferer 142 with a request for an encrypted common key (Step S61), acquires the encrypted common key (Step S62), and decrypts the common key (Step S63). The receiving client 60 also provides the transferer 142 with a request for time-section start information and time-section end information (Step S64), and acquires the information (Step S65). The receiving client 60 then provides the transferer 142 with a request for encrypted machine data (Step S66), acquires the encrypted machine data (Step S67), and decrypts the machine data (Step S68). The receiving client 60 then determines whether the time section ends (Step S69). If determining that the time section does not end (Step S69; No), the receiving client 60 repeats Step S66 and the following steps. In contrast, if determining that the time section ends (Step S69; Yes), the receiving client 60 repeats Step S61 and the following steps. These steps can achieve acquisition of a common key and decryption of machine data with the acquired common key in a new time section.

The order of the steps in FIG. 10 may be arbitrarily changed. For example, only the time-section start information may be transmitted in Steps S64 and S65, followed by transfer of the time-section end information in an additional step between Steps S68 and S69. This modified configuration allows the receiving client 60 to determine the end of a time section in real time. Alternatively, in the case where the receiving client 60 reads the data directly from the DB 52 without a request to the DB server 51, the process may exclude Steps S61, S64, and S66.

As described above, the encryptor 42 encrypts machine data with encryption keys different among the predetermined time sections. This configuration can prevent machine data from being continuously leaked in the case of leakage of an encryption key. The configuration can therefore reduce the risk in the case of leakage of data in facilities represented by factories. Specifically, the configuration can prevent machine data from being leaked at a transmission path between the flow controller 141 and each of the process executors 130 and the collection processors 160, and also prevent machine data from being continuously leaked in the case of leakage of an encryption key. In addition, the configuration can avoid an increase in data traffic due to transfer of encryption keys, because of the flexibly variable correspondence relationship between machine data and encryption key.

In some cases, the process executors 130 and the collection processors 160 may be achieved by programs developed by a vendor different from the manufacturer that provides the data management apparatus 10. In the above-described data management apparatus 10, the encryption key for encryption of machine data is a common key, and is transferred by the transferer 142 after being encrypted with a public key for the receiving client 60, which corresponds to any of the process executors 130 and the collection processors 160. Each of the process executors 130 and the collection processors 160 thus processes the machine data assigned to the own processor and cannot read the content of other encrypted data. The data management apparatus 10 can therefore be prepared for contingencies, represented by abuse of data by the process executor 130 or the collection processor 160 provided by a third party.

The DB 52 accumulates information including encrypted common keys and the encrypted machine data provided from the sending client 40, and the receiving client 60 acquires an encrypted common key and encrypted machine data from the DB 52 and decrypts the acquired data as required. The receiving client 60 can thus acquire and process necessary information depending on the own processing capacity. Even in the case of leakage of any of the stored encrypted common keys or encrypted machine data, the content of the common key or the machine data is not leaked because the data is encrypted.

The time-section start information and the time-section end information, which are time-section information on time sections, are transferred from the sending client 40 to the receiving client 60. Specifically, the DB 52 stores a common key and time-section information indicating the time section involving encryption with the common key, in association with each other, and the receiving client 60 decrypts machine data with the common key associated with this time-section information stored in the DB 52, in the time section indicated by the time-section information. The receiving client 60 can therefore acquire machine data by decrypting the encrypted machine data while certainly determining the start and end of a time section.

The time section is defined in accordance with the setting received by the receiver 120. The user of the data management apparatus 10 can thus arbitrarily set a time section. For example, the user can employ a short time section so as to prevent leakage of information and improve the security, and can employ a long time section so as to reduce the processing loads of encryption and decryption.

Mutually different encryption keys are set for a plurality of process executors 130 and collection processors 160. Specifically, as illustrated in FIG. 8, different common keys are generated and used for the individual process executors 130 and the individual collection processors 160, which are destinations of machine data. This configuration can prevent machine data from being viewed with bad intentions by the other processor among the process executors 130 and the collection processors 160.

The encryptor 42 encrypts machine data with the encryption key in accordance with the cryptosystem associated with the time section. That is, after switching of the time section, the sending client 40 encrypts machine data in accordance with a cryptosystem different from the cryptosystem in the previous time section. This configuration using various cryptosystems can prevent continuous leakage of sequentially transmitted machine data pieces, even if any cryptosystem is found to be vulnerable.

The encrypted common keys different among the time sections are transferred from the sending client 40 to the receiving client 60. In an exemplary case of using keys different among divided parts of the content, keys for decryption of the digital contents are embedded in the encrypted contents after being encrypted in a public key cryptosystem. The keys having one-to-one correspondence with the digital contents are thus transferred together with the digital contents. If the amount of data of the keys is small relative to that of the digital contents, the transfer of the keys causes a relatively small increase in data traffic. In contrast, in some cases where data having a relatively small amount is transferred in facilities represented by factories, the transfer of the keys may cause a significant increase in data traffic. The data traffic caused by transfer of information on encryption keys can be reduced by the data management system 100 according to the embodiment, in which encrypted common keys different among the time sections are transferred.

The above-described embodiment of the present disclosure is not to be construed as limiting the scope of the present disclosure.

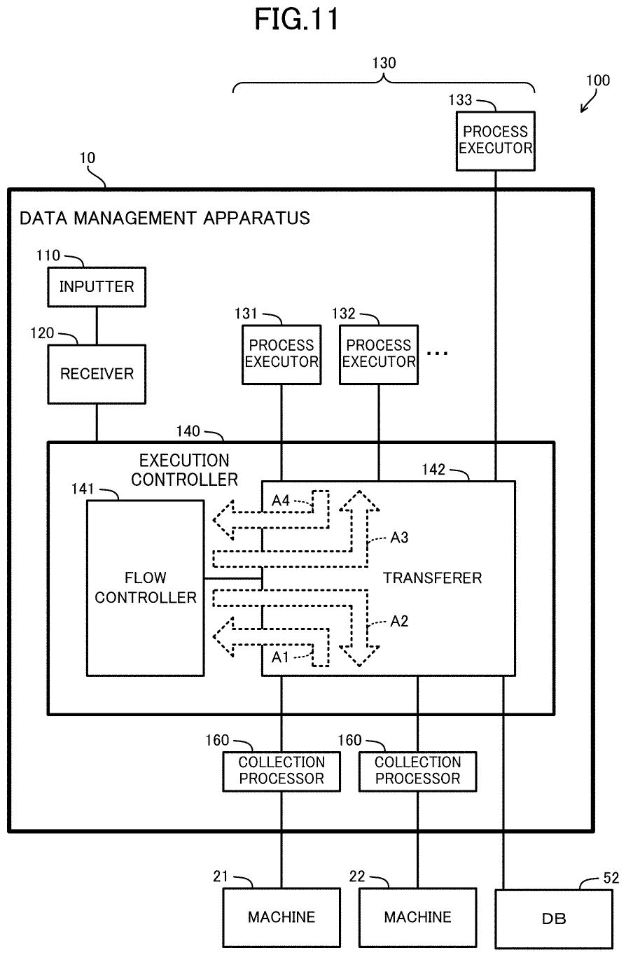

For example, as illustrated in FIG. 11, the data management apparatus 10 may also include an inputter 110 to allow the user to input information. The transferer 142 of the data management apparatus 10 may exclude the DB 52 for storing encrypted common keys and encrypted machine data, and cause a DB 52 outside the data management apparatus 10 to store the encrypted common keys and the encrypted machine data. The data management system 100 may be configured without the transferer 142 in the data management apparatus 10, and a server outside the data management apparatus 10 may perform the function of providing encrypted machine data, which corresponds to the function of the transferer 142. The data management system 100 may include a process executor 133 outside the data management apparatus 10.

The encryption key is not necessarily a common key. The sending client 40 may encrypt machine data with a public key for the receiving client 60.

The sending client 40 encrypts machine data with encryption keys different among the time sections. The sending client 40 is only required to encrypt machine data with an encryption key in each time section, which is different from the encryption key in the previous time section. In other words, an encryption key that has been used once may be used again in future.

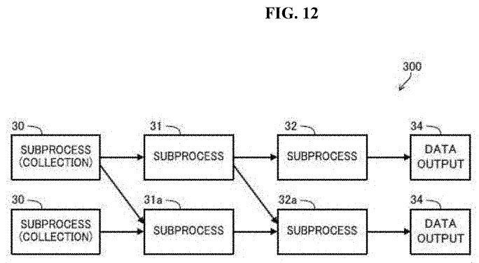

The relatively simple processing flow illustrated in FIG. 3 in the above embodiment is a mere example, and the processing flow may have a more complicated configuration. For example, as illustrated in FIG. 12, the processing flow may have a branch from the subprocess 30 into subprocesses 31 and 31a, and a confluence from the subprocesses 31 and 31a into a subprocess 32a.

Although the time-section start information and the time-section end information are used in the above embodiment, this is a mere example. The time-section end information may be excluded if the end of a certain time section is located immediately before the point indicated by the subsequent time-section start information. Also, the time-section start information may be excluded if the start of a certain time section is located immediately after the point indicated by the previous time-section end information.

The functions of the data management apparatus 10 may be achieved by dedicated hardware or an ordinal computer system.

For example, the program P1 to be executed by the processor 11 may be stored in a non-transitory computer-readable recording medium for distribution and then installed in a computer to configure an apparatus for performing the above-described processes. Conceivable examples of such a non-transitory recording medium include a flexible disk, a compact disc read-only memory (CD-ROM), a digital versatile disc (DVD), and a magneto-optical disc (MO).

The program P1 may also be stored in a disk drive included in a server apparatus on a communication network, represented by the Internet, and may be downloaded into a computer by being superimposed on a carrier wave, for example.

Alternatively, the program P1 may be activated while being transferred through a communication network to perform the above-described processes.

A server apparatus may execute all or part of the program P1 and a computer may execute a program while transmitting and receiving information on the executed processes to and from the server apparatus via a communication network, to perform the above-described processes.

In the case where the above-described functions are achieved by an operating system (OS) or by cooperation of the OS and applications, only the components other than the OS may be stored in a non-transitory medium for distribution or downloaded into a computer, for example.

The functions of the data management apparatus 10 may also be performed by means other than software. Part or all of the functions may be performed by dedicated hardware including circuits.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for processing of data.

### REFERENCE SIGNS LIST

10 Data management apparatus
11 Processor
12 Main storage
13 Auxiliary storage
14 Inputter
15 Outputter
16 Communicator
17 Internal bus
20 Network
21, 22 Machine
300 Processing flow
30-34, 31a, 32a Subprocess
40 Sending client
41 Data processor
42 Encryptor
43 Common key generator
44 Public key storage
51 DB server
60 Receiving client
61 Decryptor
62 Data processor
63 Secret key storage
64 Common key storage
100 Data management system
101 Input device
110 Inputter
120 Receiver
130-133 Process executor
140 Execution controller
141 Flow controller
142 Transferer
160 Collection processor
511 Input-output unit
521 Key data accumulator
522 Machine data accumulator
P1 Program

1. A data management apparatus comprising:
a collection processor to collect machine data pieces repetitively transmitted from a machine; and
an execution controller to (i) relay data transmitted and received between the collection processor and a first processor, of processors, that executes any one of subprocesses involved in a processing flow, the processing flow being applied to the machine data pieces and (ii) relay data transmitted and received between the first processor and a second processor of the processors, thereby causing the processors to execute the respective subprocesses in an order in accordance with the processing flow, wherein
the execution controller comprises
a common key generator to generate first common keys that are different among predetermined first time sections,
an encryptor to encrypt data pieces to be transmitted to the processors with the respective first common keys,
a storage to store data pieces encrypted by the encryptor and data pieces encrypted by the processors from which the corresponding data pieces are transmitted,
a provider to provide the data pieces stored in the storage, and
a receiver to receive, from the provider, data pieces encrypted by the processors with respective second common keys that are different among predetermined second time sections and decrypt the received data pieces,
the encryptor encrypts the first common keys with a public key for the processors,
the storage stores the first common keys encrypted by the encryptor and the second common keys encrypted by the processors with a public key for the receiver, and
the receiver acquires the second common keys stored in the storage and decrypts the acquired second common keys with a secret key for the receiver.

2. (canceled)

3. The data management apparatus according to claim 1, wherein
the storage stores the first common keys and first time-section information pieces in association with each other, and the second common keys and second time-section information pieces in association with each other, the first time-section information pieces indicating the first time sections involving execution of encryption with the respective first common keys, the second time-section information pieces indicating the second time sections involving execution of encryption with the respective second common keys, and
in each of the second time sections indicated by the second time-section information pieces stored in the storage, the receiver decrypts data pieces with the second common key associated with the corresponding second time-section information piece.

4. The data management apparatus according to claim 3, wherein the first time-section information piece relates to at least one of start or end of the first time section.

5. The data management apparatus according to claim 1, further comprising:
a setting receiver to receive setting for the first time sections, wherein
the encryptor encrypts data pieces with the first common keys that are different among the first time sections, the first time sections being defined in accordance with the setting received by the setting receiver.

6. The data management apparatus according to claim 1, wherein the encryptor encrypts data pieces to be transmitted respectively to the processors with the mutually different first common keys.

7. The data management apparatus according to claim 1, wherein the encryptor encrypts data pieces with the first common key in accordance with a cryptosystem associated with the corresponding first time section.

8. A data management method implementable by a data management apparatus including a collection processor to collect machine data pieces repetitively transmitted from a machine, and an execution controller to (i) relay data transmitted and received between the collection processor and a first processor, of processors, that executes any one of subprocesses involved in a processing flow, the processing flow being applied to the machine data pieces and (ii) relay data transmitted and received between the first processor and a second processor of the processors, thereby causing the processors to execute the respective subprocesses in an order in accordance with the processing flow, the data management method comprising:
generating, by a common key generator of the execution controller, first common keys that are different among predetermined first time sections;
encrypting, by an encryptor of the execution controller, the first common keys with a public key for the processors;
storing, by the encryptor, the encrypted first common keys to a storage;
acquiring, by a receiver of the execution controller, second common keys that are stored in the storage and encrypted with a public key for the receiver, and decrypting, by the receiver, the acquired second common keys with a secret key for the receiver;
encrypting, by the encryptor, data pieces to be transmitted to the processors with the first common keys;
causing, by the encryptor, the encrypted data pieces to be stored in the storage;
providing, a provider of the execution controller, to the processors the data pieces that are stored in the storage and encrypted by the encryptor;
providing, by the provider, to the receiver data pieces that are stored in the storage and encrypted by the processors from which the corresponding data pieces are transmitted with the respective second common keys that are different among predetermined second time sections; and
receiving, by the receiver, the data pieces encrypted by the processors and decrypting, by the receiver, the received data pieces.

9. A non-transitory computer-readable recording medium storing a program, the program causing a computer to be connected to a machine to function as:
a collection processor to collect machine data pieces repetitively transmitted from the machine; and
an execution controller to (i) relay data transmitted and received between the collection processor and a first processor, of processors, that executes any one of subprocesses involved in a processing flow, the processing flow being applied to the machine data pieces and (ii) relay data transmitted and received between the first processor and a second processor of the processors, thereby causing the processors to execute the respective subprocesses in an order in accordance with the processing flow, wherein
the execution controller comprises
a common key generator to generate first common keys that are different among predetermined first time sections,
an encryptor to encrypt data pieces to be transmitted to the processors with the respective first common keys,
a storage to store data pieces encrypted by the encryptor and data pieces encrypted by the processors from which the corresponding data pieces are transmitted,
a provider to provide the data pieces stored in the storage, and
a receiver to receive, from the provider, data pieces encrypted by the processors with respective second common keys that are different among predetermined second time sections and decrypt the received data pieces,
the encryptor encrypts the first common keys with a public key for the processors,
the storage stores the first common keys encrypted by the encryptor and the second common keys encrypted by the processors with a public key for the receiver, and
the receiver acquires the second common keys stored in the storage and decrypts the acquired second common keys with a secret key for the receiver.

10. The data management apparatus according to claim 1, wherein the first time sections are sections that are predetermined to be divided depending on a value of a data piece encrypted with the corresponding first common key.
